(19) United States
(12) Patent Application Publication
(10) Pub. No.: US 2018/0144399 A1
(43) Pub. Date: May 24, 2018

(54) REAL TIME BIDDING METHOD

(71) Applicant: FRANK MESSINEO, TOTOWA, NJ (US)

(72) Inventor: FRANK MESSINEO, TOTOWA, NJ (US)

(21) Appl. No.: 15/816,489

(22) Filed: Nov. 17, 2017

Related U.S. Application Data
(60) Provisional application No. 62/424,049, filed on Nov. 18, 2016.

(51) Int. Cl. G06Q 30/08

(52) U.S. Cl. CPC G06Q 30/08

(57) ABSTRACT

A bidding system and method may include a communication network based portal that communicates with a server the communications network. An architect or manager enters project information into a project database to solicit bids from any number of general contractors or the like. The general contractor may, in turn, send each selected subcontractor an invitation to contribute to their bid. The general contractor uses the bid information from the subcontractors to prepare and submit a bid to the architect or manager via the bidding system.

### CLAIM OF PRIORITY

This application claims priority to U.S. Provisional Patent Application No. 62/424,049, filed Nov. 18, 2016, incorporated by reference herein in its entirety.

### FIELD OF THE EMBODIMENTS

The field of the embodiments of the present invention relate to systems and methods for submitting bids for a construction project. Namely, by accepting bids in a standardized format over a communications network and allowing project information to be readily viewed.

### BACKGROUND OF THE EMBODIMENTS

The job of the manager or architect involves more than just sending out a bid and picking the lowest bidder. In addition to overseeing the job, addressing issues that might arise during the job, processing invoices for payment to the general contractor, and conducting the final walk through to ensure that the job was completed as contracted; the manager must also review contractor bids and award the bid to the desired general contractor.

To perform this part of their work, the manager will typically examine the bids submitted by the general contractors that were invited to bid or who otherwise submitted a bid. The manager may also review line items on the general contractors' bids to site any glaring discrepancies or oversights.

However, the current process of reviewing the bid documents for discrepancies, adjustments in allowances, identification of varying exclusions is not a simple task. The reason for this is lace of a consistent method and system not only from general contractor to general contractor, but from subcontractor to subcontractor. Considering that general contractors typically solicit bids from at least three subcontractors in each various trade categories, and that the manager would typically solicit bids from at least three different general contractors, an average job may include subcontractor bids from over one hundred possible companies. In addition to most likely presenting the bids from the different trades in different orders, different general contractors may include specific work in different trade categories.

At the end of the day, the manager is often left to the task of deciphering bids from multiple general contractors who all present their information in different formats and who each solicit bids from dozens of subcontractors, with none of the subcontractors using the same software and all with varying degrees of detail. As a result, before a bid is awarded by the manager, hours of work are typically spent double-checking bids, confirming inclusions and exclusions by all contractors, and recalculating bid amounts.

Thus, a need therefore exists for a multi-tiered web-based software system that allows a manager to dictate the format and level of detail that will be presented for not only the general contractors supplying bids, but all of the subcontractors of those general contractors as well. The present invention and its embodiments meets and exceeds these objectives.

### Review of Related Technology

U.S. Pat. No. 7,783,554 pertains systems and methods for securely archiving detailed bid information for later use in change order negotiation, conflict resolution, or other matters is presented. A bid containing detailed information is received at a central archive server. Upon receipt of the bid, the server timestamps and encrypts the bid. A decryption key is provided to the party who submitted the bid. The encrypted bid is then stored in a data storage area. for later use. The archived bid can be compressed to optimize data storage. Upon a request by the party who submitted the bid, the bid is retrieved from data storage, decompressed if necessary, and decrypted with a key provided by the requesting party. The detailed bid information can then be used to resolve disputes, negotiate change orders, or otherwise.

U.S. Patent Application 2008/0103958 pertains to a construction bidding system and method includes manager, general contractor and subcontractor workstations that communicate with a server hosting a website over a network such as the Internet. The server also communicates with a number of databases. A manager enters project information into a project database and selects general contractors from a general contractor database. The manager sends each selected general contractor an invitation to bid. A general contractor receives the invitation to bid, reviews the project information and selects subcontractors from a subcontractor database. The general contractor sends each selected subcontractor an invitation to bid. A subcontractor receives the invitation to bid and responds with bid information that is entered in to a bid database. The general contractor uses the bid information from the subcontractors to prepare and submit a bid to the manager.

U.S. Patent Application 2003/0101127 pertains to an Internet-based construction bid management system that can be accessed and utilized by construction project owners, general contractors, subcontractors, vendors, and other parties interested in the construction bidding process. The system accommodates the posting of projects, the submission of bids, the distribution of construction drawings, and the collection of historical bid results, via any number of networked computer devices. The automated nature of the system ensures that the current bid status of any number of projects can be quickly updated for immediate access by the various participants.

Various systems and methodologies are blown in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

In general, the present invention and its embodiments provide for a bidding system and method may include a communication network based portal that communicates with a server the communications network. An architect or manager enters project information into a project database to solicit bids from any number of general contractors or the like. The general contractor may, in turn, send each selected subcontractor an invitation to contribute to their bid. The general contractor uses the bid information from the subcontractors to prepare and submit a bid to the architect or manager via the bidding system.

In at least one embodiment of the present invention there is a computer program embodied in a non-transitory computer-readable medium comprising computer readable instructions, which when executed by a processor, cause the processor to perform the steps of establishing, via the processor, a bid portal for at least one project; soliciting, via the processor, an invitation to make a bid by at least one bidder; receiving, via the processor, at least one bid for the at least one project; analyzing, via the processor, the at least one bid for compliance with the bid portal; accepting, via the processor, the at least one bid for inclusion in a bid pool

In another embodiment of the present invention there is a system for bid management, the system comprising: a computing device having a display, wherein the computing device has at least a processor and a memory, the memory being communicatively coupled to the processor and the memory storing computer readable instructions that when executed by the processor cause the processor to perform the steps of establishing, via the processor, a bid portal for at least one project, wherein the bid portal comprises a named, date, location, budget, project contact, and diagrams; soliciting, via the processor, an invitation to make a bid by at least one bidder, wherein the at least one bidder meets an eligibility criteria; receiving, via the processor, at least one bid for the at least one project; analyzing, via the processor, the at least one bid for compliance with the bid portal, wherein if non-compliance is noted, then a notification is send to the at least one bidder; and accepting, via the processor, the at least one bid for inclusion in a bid pool.

In another embodiment of the present invention there is a computer implemented method of bid management of at least one user, the method comprising the steps of establishing, via the processor, a bid portal for at least one project, wherein the bid portal comprises a named, date, location, budget, project contact, and diagrams; soliciting, via the processor, an invitation to make a bid by at least one bidder, wherein the at least one bidder meets an eligibility criteria; receiving, via the processor, at least one bid for the at least one project; analyzing, via the processor, the at least one bid for compliance with the bid portal, wherein if non-compliance is noted, then a notification is send to the at least one bidder; and accepting, via the processor, the at least one bid for inclusion in a bid pool.

In general, the present invention succeeds in conferring the following, and others not mentioned, benefits and objectives.

It is an object of the present invention to provide a system that enables bids for a construction project to be submitted over a communications network.

It is an object of the present invention to provide a system that enables viewing of details of a construction project over a communications network.

It is an object of the present invention to provide a system that allows electronic messages to be sent to individuals/companies interested in a particular construction project.

It is an object of the present invention to provide a system that allows bidders to be rated and scored.

It is an object of the present invention to provide a system that enables document uploads and downloads.

It is an object of the present invention to provide a system that enables project modification.

It is an object of the present invention to provide a system that shows biddable items as part of a construction project.

### BRIEF DESCRIPTION OF THE DRAWINGS

FIG. 1 is an example screen of an account dashboard.

FIG. 2 is a second example screen of an account dashboard.

FIG. 3 is an example screen of an electronic mail portal.

FIG. 4 is an example screen of a rating report.

FIG. 5 is an example screen of a bidder setup.

FIG. 6 is an example screen of a bidder list.

FIG. 7 is an example screen of a document generator.

FIG. 8 is an example screen of a maintenance dashboard.

FIG. 9 is an example screen of a project set up.

FIG. 10 is a second example screen of a project set up.

FIG. 11 is an example screen of a project status dashboard.

FIG. 12 is an example screen of a required document set up.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

### Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information m be processed. These information technology systems may be used to collect data for later retrieval, analysis, and manipulation, which may be facilitated through a database program. These information technology systems provide interfaces that allow users to access and operate various system components.

In one embodiment, the present invention may, be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s) server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), canning console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

### Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1 EDR, FM, etc.); a Broadcom BCM4750IUB8 receiver chip (e.g., GPS), an Infineon Technologies X-Gold 618-PMB9800 (e.g., providing 2G/3G HSDPA/HSUPA communications); and/or the like.

The system dock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of napping and addressing memory beyond the processor itself internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”) and/or the like embedded technology. For example, any of the component collection (distributed or otherwise) and/or features of the present invention may be implemented via the microprocessor and/or via embedded components; e.g., via ASIC, coprocessor, DSP, FPGA and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then ligated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

### Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

### Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus, The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture. ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g. code division multiple access (CDMA), high speed packet access (HSPA(+)), high-speed downlink packet access (HSDPA), global system for mobile communications (GSM), long term evolution (LTE) WiMax, etc.): and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also he used. Other commercially available specialized cryptographic processors include: the Broadcom's CryptoNetX and other Security Processors: nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD RIRW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory may contain a collection of program anti: or database components and/or data such as, but not limited to: operating system component(s) (operating system); information server component(s) (information server); user interface component(s) (user interface); Web browser component(s) (Web browser); database(s); mail server component(s), mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

### Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be am on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

### Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX., (ANSI) (Objective-) C(++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes. Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests fir information at specified locations on the controller of the present invention based on the remainder of the HTTP request. For example, a request such as http://123.124,125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like. Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search. string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaSeript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component is a stored program component that is executed by a CPU. The Web browser may be a conventional hypertext viewing application such as Microsoft Internet Explorer or Google Chrome, Firefox, etc. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

### Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C(++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), international Data. Encryption Algorithm (IDEA), Message Digest 5 (MD5, which is a one way hash function), passwords Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications requests, and/or responses.

### A Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, Object Store, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

### Embodiments of the Present Invention

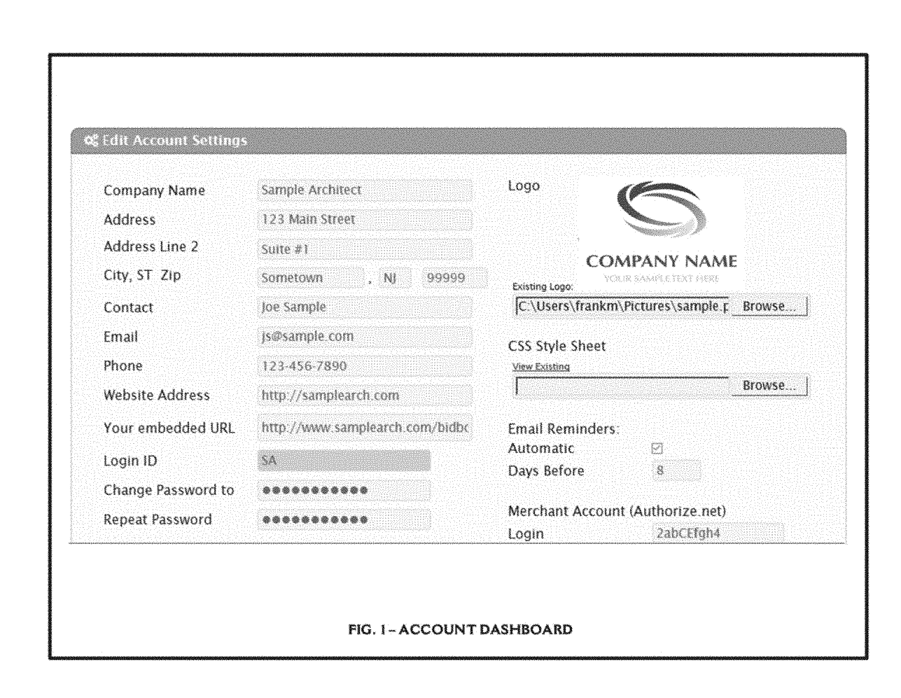

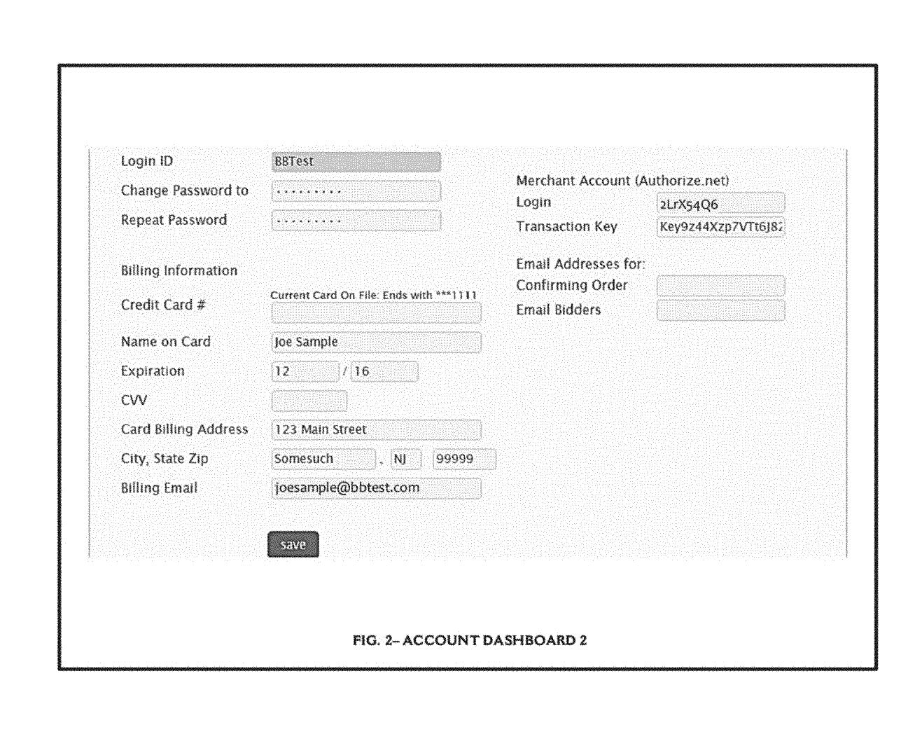

Referring now to FIGS. 1 and 2, there is an example screen of an account dashboard consistent with the present invention. As shown, when first signing up to use the service, one must create an account through this dashboard.

Users may provide personal information and location information such as but not limited to company name, address, city, state, zip code, company contact, email addresses, phone numbers, fax numbers, etc. Further, identifying avatars such as logos, pictures, and the like may be uploaded to the user account. A user must also select credentials in the form of at least a user name and password. Billing information for the company or user may also be provided, preferably in the form of a credit card account number and the requisite information associated with that account. Such information will be used to process payments in accordance with the present invention.

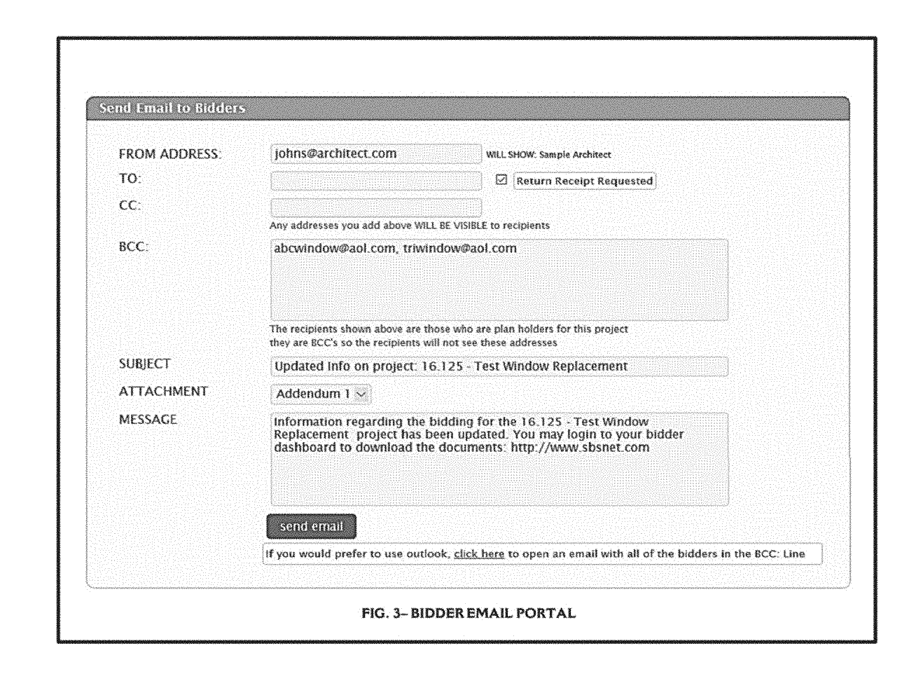

FIG. 3 shows an illustrative view of an electronic message portal contemplated under the present invention. Here, one can construct an electronic message, select recipients, and attach information as needed. Various other functionality may be included to as read receipts, and delivery confirmation may also be included.

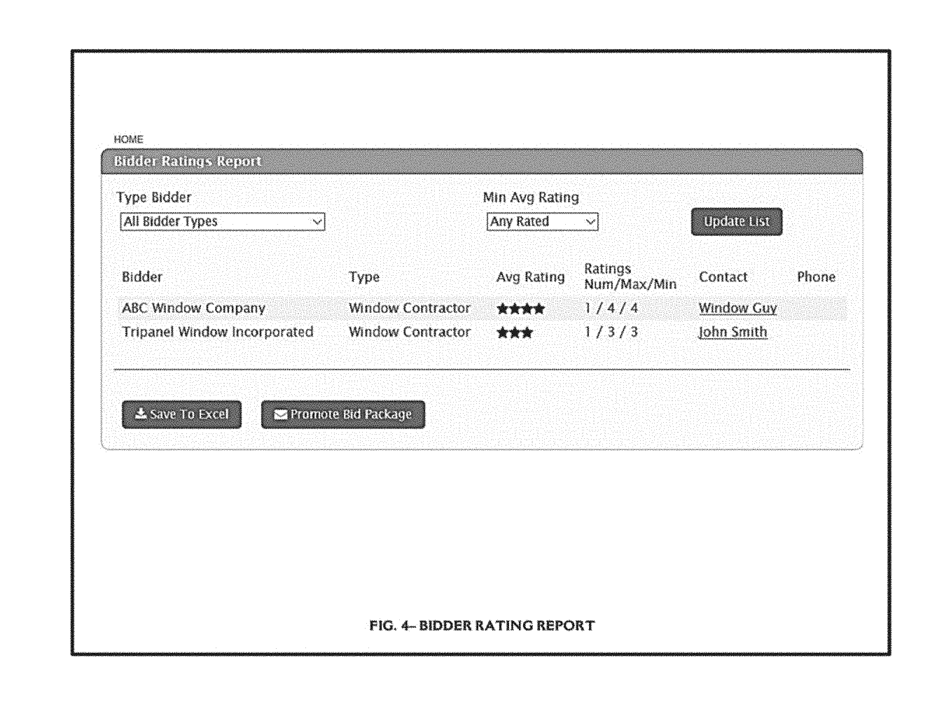

Referring now to FIG. 4, there is a bidder ratings report screen. The bidder rating report screen contains information about a rating process for bidders. The rating process may be relegated to individuals rating a performance on a particular job or may be the result of multiple scores average together. In some embodiments, the rating or score is the result of an algorithm that takes into account factors such as competitiveness of bids, job completion rate, number of subcontractors used, and the like or some combination thereof.

A user can view the potential bid pool and sort by bidder type and further filter by the rating of the bidder. This allows certain bidders to be viewed and further may allow a bid package to be sent to certain bidders but not others due to a number of factors including their ranking within the system.

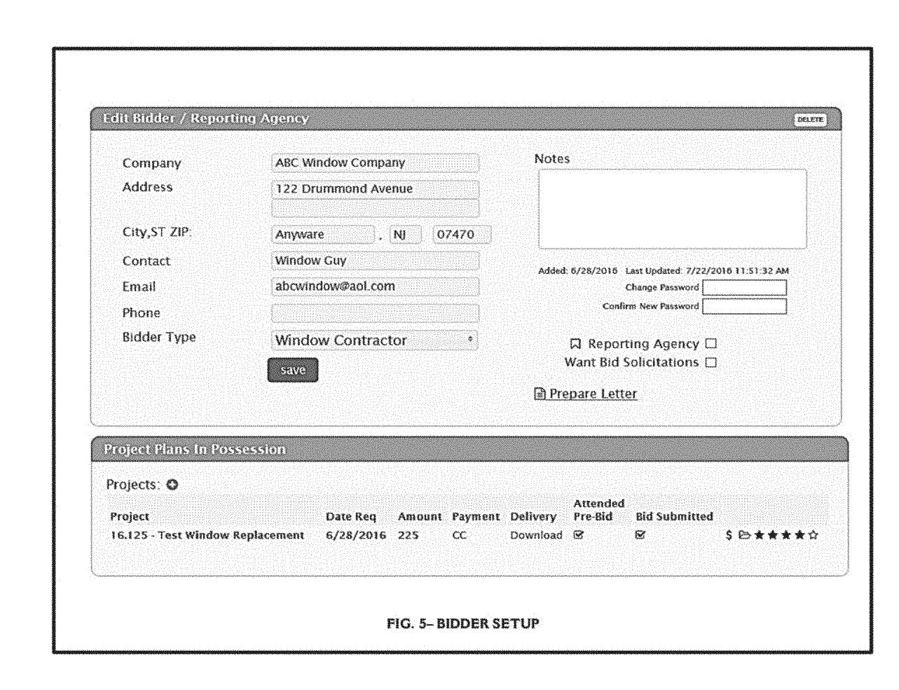

FIG. 5 illustrates a potential bidder setup screen. Here, a bidder would enter their requisite contact and identifying information to facilitate the bidding process. Further, the bidder would identify themselves as a bidder type to distinguish one trade from another in the system. The bidder can also see the plans in their possession or requested, payment status, whether a bid has been submitted, and their rating.

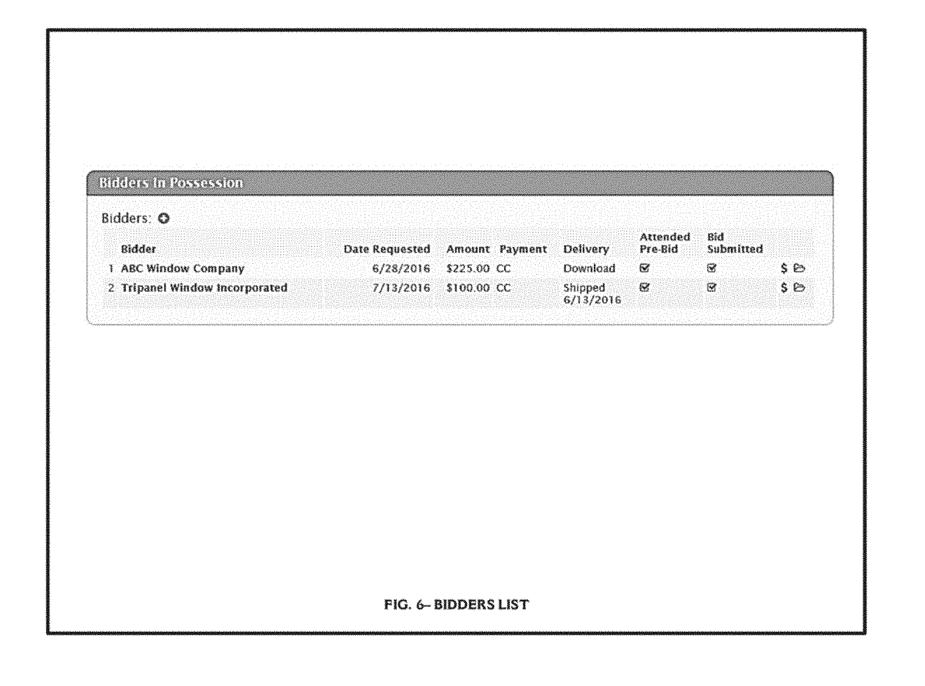

FIG. 6 illustrates a bidder list that the architect or manager would see in order to track the bidders and the variables associated therewith. The bidder name is preferably listed as well as dates of requesting of materials, amount of money paid/owed, form of payment, method of delivery, and whether the bidder has attended a pre-bid meeting and submitted a bid. A manager may review such a screen periodically to determine if he needs to communicate with any of the bidders or if anything is incomplete.

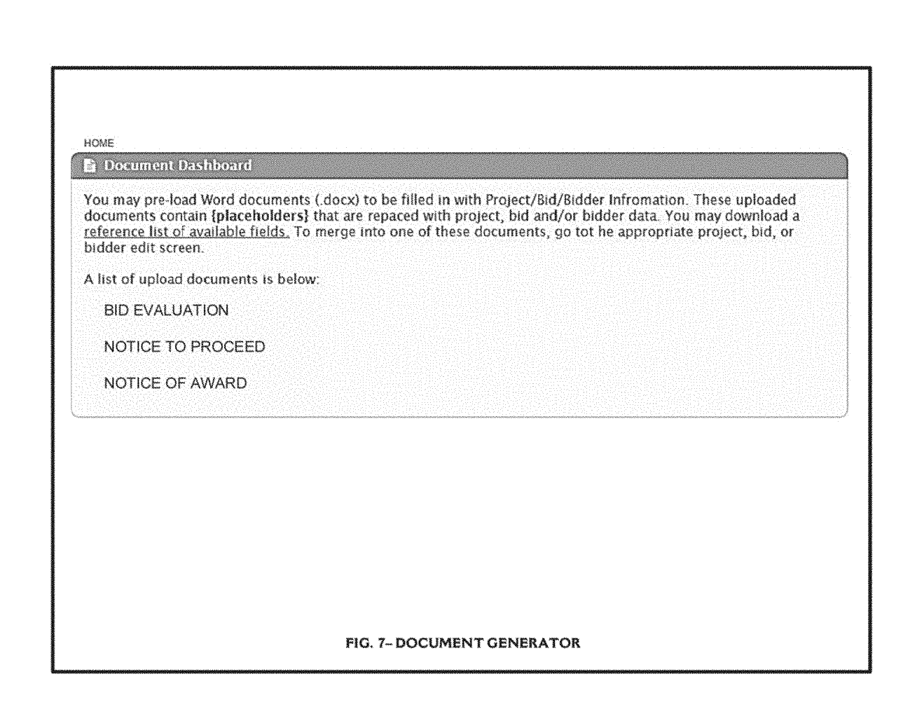

FIG. 7 illustrates a document generator screen where documents may be uploaded to the portal in order to make the documents accessible to the system. In some instances, pre-filled documents are uploaded that contain template language with various fields denoted to be replaced per the requirements for that particular communication. In some instances, information about a project may be able to be merged into one of the template documents. Such a merger would allow for identification of certain coded fields. The identification of the coded fields would match up with information in the uploaded bid documents or information thereby allowing one click creation of custom communications to be sent in a variety of formats to a number of recipients.

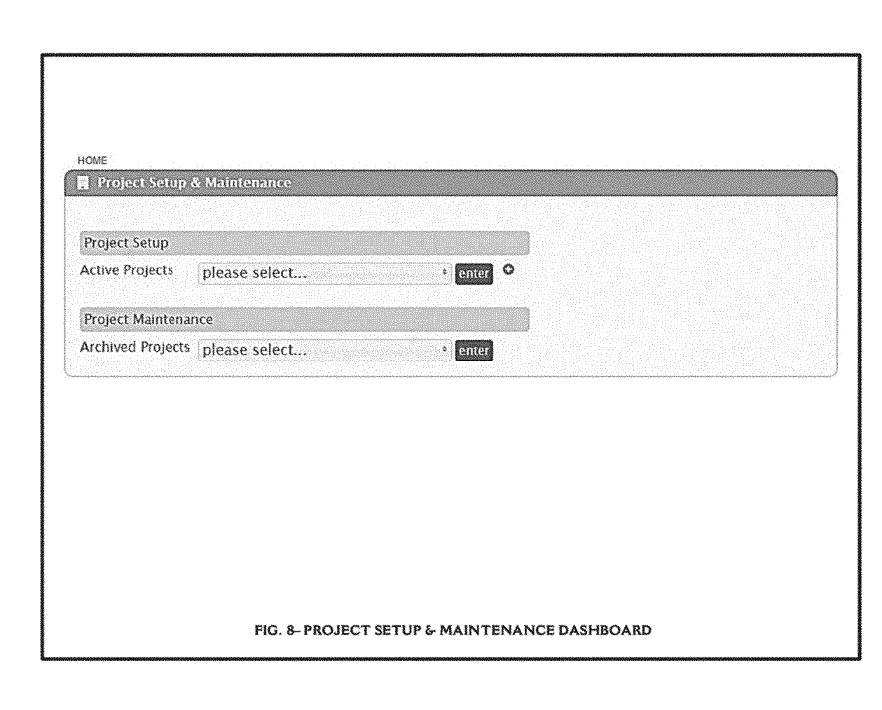

FIG. 8 demonstrates a project maintenance dashboard. Here, the manager can view and select active projects, as well as view and select archived or past projects. A user need simply to select the required project from the drop down menu and hit enter to view the selected project.

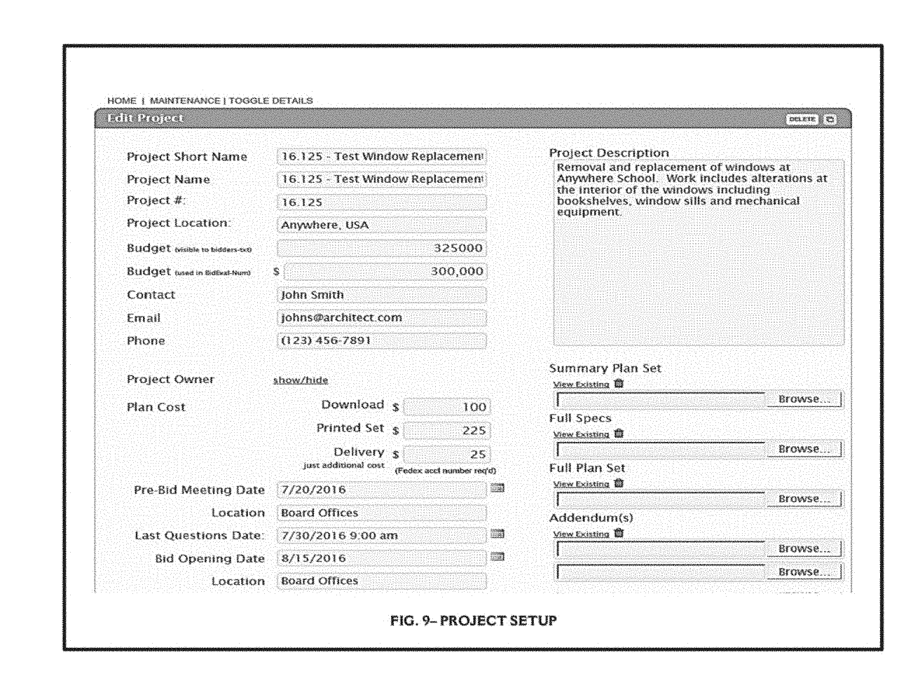

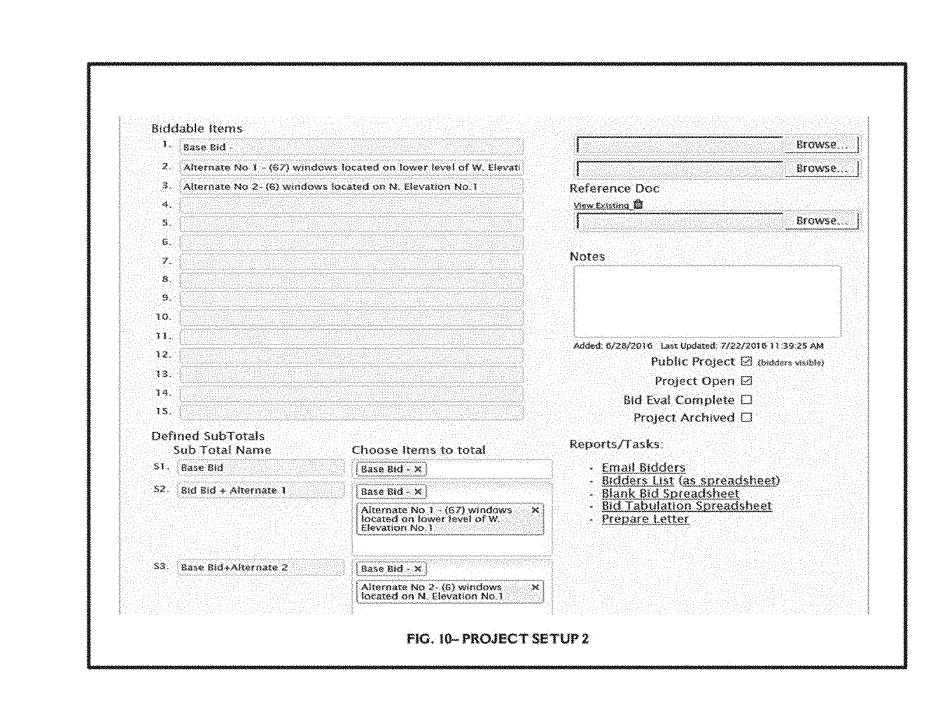

In FIGS. 9-10, there is a project set up dashboard represented in the drawings. Here, the manager can enter all the project variables such that they are viewable (if selected to be viewable) by the prospective bidders. Information relating to the project name, location, budget, owner(s), meeting times, meeting locations, and plan sets can also be viewed and accessed. Further, the items which may be bid upon are also present. In some embodiments, there may be various combinations biddable items of interest to the manager. Thus, the manager can create sub-bids for certain combinations to see how those items are priced together.

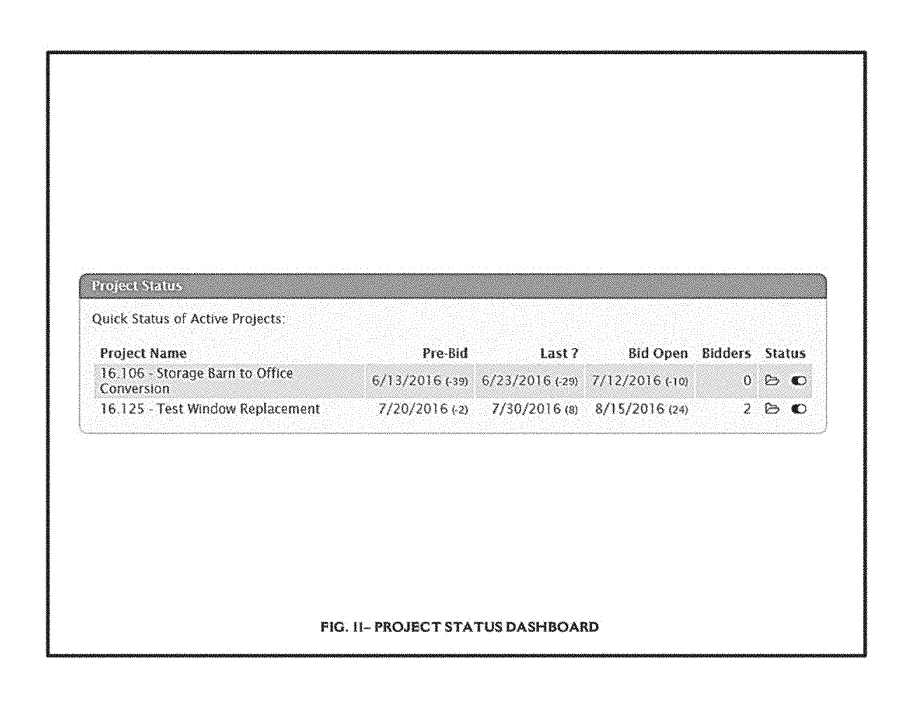

FIG. 11 represents a project status dashboard where the manager can view the active projects determine the bidding timeline (from opening, questions, closing, etc.) and the number of bidders.

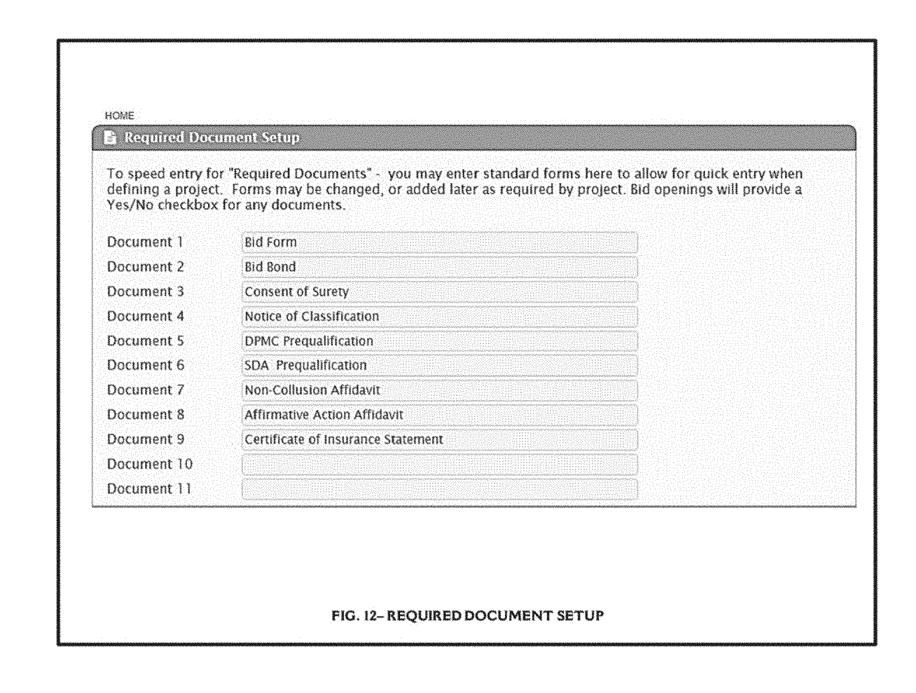

FIG. 12 is an exemplary required document set up screen wherein the manager may enter standard forms for bid portal.

In practice, an architect or manager can set up a bid portal via a communications network. Such a portal may take the form of a website. Once one accesses the site, the system will check to determine if it is the first time a person is a visitor. A new user may be prompted to create an account whereas a previous user may be prompted to log-in.

Once an account has been created, the user or potential bidder will be able to view projects inputted by the manager. The manager, in accordance with the screens described above, can enter project variables for view and saving. The bidder then accesses each of the projects to review the needs of each project.

The bidder can then gather the necessary documents from the portal as the documents will have been uploaded by the manager. The bidder can formulate a bid using their own company and/or various subcontractors. The bidder can then submit their bid to the portal for view and potential selection by the manager.

Further, all other aspects of the bid process between the manager and the bidder(s) is fully automated by the portal described herein. Meetings can be schedules, emails sent to bidders, emails sent to managers, etc. This “one stop shop” allows the bidding process to be streamlined in a way that enhances the bids received and increases the over quality of the work performed.

In addition, other modules/functionality are contemplated under the purview of this invention and its embodiments. For example, a project management module may have a project set up feature in hiding client information (including but not limited to client type), scope of work to be performed, fee types, work phase breakdown, billing worksheets, resource management, and consultant management.

A fee proposal calculator may be employed to help one generate and estimate various costs associated with a particular project. For example, the calculator may include an estimation of staffing hours of the various project phases, consultant fee calculations, overall proposal fees (with breakdowns between staffing, materials, etc.), adding of consultants for a particular project, and various fee breakdowns.

An additional work order and services from generator may also be implemented in some embodiments. In one instance, this may be applicable for contracted customers which allows far the simple completion of a pre-populated form when being asked to complete a particular task or series of tasks under a particular contract. This, in turn, eliminates or reduces the need for repetitive proposals and allows for electronic transmission to client for approval.

Further, such a module or implementation may allow for the simple completion of a pre-populated form for additional services to be performed and hither allows for electronic transmission to the client for approval.

Although this invention has been described with a certain degree of particularly, it is to be understood that the present disclosure has been made only by way of illustration and that numerous changes in the details of construction and arrangement of parts may be resorted to without departing from the spirit and the scope of the invention.

What is claimed is:

1. A computer program embodied in a non-transitory computer-readable medium comprising computer readable instructions, which when executed by a processor, cause the processor to perform the steps of:
establishing, via the processor, a bid portal for at least one project;
soliciting, via the processor, an invitation to make a bid by at least one bidder;
receiving, via the processor, at least one bid for the at least one project;
analyzing, via the processor, the at least one bid for compliance with the bid portal; and
accepting, via the processor, the at least one bid for inclusion in a bid pool.

2. The medium of claim 1 further comprising the step of:
notifying, via the processor, of a selection of at least one bid for the at least one project.

3. The medium of claim 2 wherein the notifying is completed via an electronic message.

4. The medium of claim 1 wherein the at least one bid comprises at least a bid form, bid bond, consent of surety, notice of classification, non-collusion affidavit, certificate of insurance or a combination thereof.

5. The medium of claim 1 farther comprising the step of:
sending an electronic message to the at least one bidder, via the processor, to update a status of the bid portal.

6. The medium of claim 1 wherein the at least one bidder has a qualifying rank.

7. A system for bid management, the system comprising:
a computing device having a display,
wherein the computing device has at least a processor and a memory, the memory being communicatively coupled to the processor and the memory storing computer readable instructions that when executed by the processor cause the processor to perform the steps of:
establishing, via the processor, a bid portal for at least one project,
wherein the bid portal comprises a named, date, location, budget, project contact, and diagrams;
soliciting, via the processor, an invitation to make a bid by at least one bidder,
wherein the at least one bidder meets an eligibility criteria;
receiving, via the processor, at least one bid for the at least one project;
analyzing, via the processor, the at least one bid for compliance with the bid portal,
wherein if non-compliance is noted, then a notification is send to the at least one bidder; and
accepting, via the processor, the at least one bid for inclusion in a bid pool.

8. A computer implemented method of bid management of at least one user, the method comprising the steps of:
establishing, via a processor, a bid portal for at least one project,
wherein the bid portal comprises a named, date, location, budget, project contact, and diagrams;
soliciting, via the processor, an invitation to make a bid by at least one bidder,
wherein the at least one bidder meets an eligibility criteria;
receiving, via. the processor, at least one bid for the at least one project;
analyzing, via the processor, the at least one bid for compliance with the bid portal,
wherein if non-compliance is noted, then a notification is send to the at least one bidder; and
accepting, via the processor, the at least one bid for inclusion in a bid pool.
